(19) United States
(12) Patent Application Publication
(10) Pub. No.: US 2021/0092227 A1
(43) Pub. Date: Mar. 25, 2021

(54) SYSTEMS AND METHODS FOR CALLER VERIFICATION

(71) Applicant: Payfone, Inc., New York, NY (US)

(72) Inventors: Jeffrey Naujok, Colorado Springs, CO (US); Christopher Cunningham, Highlands Ranch, CO (US); Greg Bonin, Denver, CO (US)

(21) Appl. No.: 17/031,696

(22) Filed: Sep. 24, 2020

Related U.S. Application Data
(60) Provisional application No. 62/905,702, filed on Sep. 25, 2019.

(51) Int. Cl. H04M 3/436; H04M 3/38; H04M 1/663; H04M 3/42

(52) U.S. Cl. CPC H04M 3/436; H04M 3/42034; H04M 1/663; H04M 3/387

(57) ABSTRACT

Briefly, claimed subject matter may relate to a caller verification system having a signaling resource for forming a communications channel for a call placed between a call source and a call destination. The signaling resource may generate a call setup record having parameters relevant to the formed communications channel. The call verification system may additionally include a call verification device that provides call parameters to the signaling resource and receives from the signaling resource, an indication of a match between the provided call parameters and the parameters of the call setup record.

### CROSS REFERENCE TO RELATED APPLICATIONS

This application claims the benefit of priority to provisional patent application Ser. No. 62/905,702, filed Sep. 25, 2019, which is incorporated by reference herein in its entirety and for all purposes.

### BACKGROUND

### 1. Field

The present disclosure relates generally to computer software systems and more specifically, but not exclusively, to systems and methods for caller verification.

### 2. Information

Communications-based fraud is one of the largest current forms of credit card fraud and identity theft in the United States, totaling several billion dollars of lost revenue annually. In an attempt to prevent communications-based fraud, some conventional fraud-prevention systems may implement minimal procedures to confirm the identify of participants, such as a caller, who may seek to perform a financial transaction, for example, via a telephone call. In some instances, a system may utilize caller identification (ID)—a telephone service that transmits a purported caller's telephone number to the called party's telephone—which service can be easily falsified and has resulted in rampant fraud across financial industries. Call centers may utilize similar technologies, such as Integrated Voice Response systems that rely on either the automatic number identification and/or caller ID parameters to identify callers. However, automatic number identification and caller ID can be easily falsified as most carriers offer a simple dialing code as well as providing step-by-step guides, which can allow unscrupulous entities to spoof telephone numbers without the need to load specialized software on either an originating or destination telephone. In fact, some online sources provide any requested number to appear on the called party's telephone without any need for specialized knowledge, specialized equipment, and/or specialized techniques/processes. Accordingly, preventing communications-based fraud, especially with respect to techniques involving telephone communications, continues to be an active area of investigation.

### SUMMARY

In one embodiment, a general aspect includes a caller verification system, includes a signaling resource that forms a communications channel for a call placed between a call source and a call destination. The signaling resource generates a call setup record having parameters relevant to the formed communications channel. The caller verification system also includes a call verification device to provide call parameters to the signaling resource, and to receive from the signaling resource, an indication of a match between the provided call parameters and the parameters of the call setup record.

In an embodiment, the caller verification system further includes one or more number allocation databases which, responsive to a query initiated at the call destination, determines a communication services carrier from a plurality of communication services carrier that formed the communications channel between the call source and the call destination. In an embodiment, the caller verification system may further include a processor to determine that the call placed between the call source and the call destination is potentially fraudulent based, at least in part, on a mismatch between the provided call parameters and the parameters of the call setup record. In an embodiment, the caller verification system may be adapted to receive a telephone number corresponding to the call source. In an embodiment, the caller verification system may additionally be adapted to transmit a query to a database to determine a trustworthiness score corresponding to a caller corresponding to the call source. In an embodiment, the database of the caller identification system may include one or more records of events that relate to a communications device corresponding to the call source. In an embodiment, the signaling resource of the caller verification system may operate in accordance with a session initiation protocol (SIP). In an embodiment, the signaling resource may operate in accordance with a signaling system 7 (SS7) protocol. In an embodiment, the call verification device may operate without user input to provide the call parameters to the signaling resource. In other embodiments, a signaling resource may operate in accordance with a protocol other than a SIP protocol, or may operate in accordance with a signaling system other than SS7, and claimed subject matter is intended to embrace all such alternative signaling resources currently implemented or to be developed in the future.

Another general aspect includes a method, which includes transmitting a query to a communication services carrier. The query may include the obtained communication parameters. The method also includes obtaining, from the communication services carrier and responsive to the transmitted query, an indication of a match between a call setup record generated by the communication services carrier and the communication parameters relevant to the call source. The method also includes generating an authentication signal, with respect to the call source, responsive to detecting agreement between the communication parameters relevant to the call source and the call setup record generated by the communication services carrier.

In an embodiment, the method further includes receiving, from a computing device, a signal to initiate transmission of the obtained communication parameters, in which the obtained communication parameters are relevant to the call source, to the communication services carrier. In an embodiment, the method may further include, prior to generating the authentication signal, accessing a database that includes the parameters relevant to the call source. In an embodiment, the call setup record generated by the communication services carrier corresponds to a signaling system 7 (SS7) record. In an embodiment, the call setup record is generated by the communication services carrier and corresponds to a SIP record. In an embodiment, the agreement between the communication parameters relevant to the call source and the call setup record generated by the communication services carrier pertain to a match between a telephone number of the call source, determined from the call setup record, and a telephone number of the call source from the obtained communication parameters.

In an embodiment, a non-transitory storage medium having instructions stored thereon is executable by a special-purpose computing platform to obtain, via an application programming interface triggered at a call destination, communication parameters relevant to a call source. The instructions stored thereon is executable by a special-purpose computing platform to transmit a query to a communication services carrier, the query including the obtained communication parameters. The instructions stored thereon is executable by a special-purpose computing platform to obtain, responsive to the transmitted query, an indication of a match between a call setup record generated by the communication services carrier and the communication parameters relevant to establishing a resource between the call source and the call destination. The instructions stored thereon is executable by a special-purpose computing platform to generate an indication of authentication with respect to the call source responsive to an agreement between the communication parameters relevant to the call destination and the call setup record generated by the communication services carrier.

In an embodiment, the instructions stored thereon is executable by a special-purpose computing platform to access a database including the parameters relevant to the call destination. In an embodiment, the instructions executable by the special-purpose computing platform are additionally to generate the call setup record in accordance with a SS7 record. In an embodiment, the instructions executable by the special-purpose computing platform are additionally to generate the call setup record in accordance with a SIP record. In an embodiment, the agreement between the communication parameters pertains to agreement between the obtained communication parameters relevant to the call destination and the call setup record generated by the communication services carrier.

### BRIEF DESCRIPTION OF THE DRAWINGS

Claimed subject matter is particularly pointed out and distinctly claimed in the concluding portion of the specification. However, both as to organization and/or method of operation, features, and/or advantages thereof, it may best be understood by reference to the following detailed description if read with the accompanying drawings in which:

FIG. 1 is a top-level block diagram illustrating a call verification system, according to an embodiment.

FIG. 2 is a system diagram of the call verification system of FIG. 1, according to an embodiment.

FIG. 3 is a system diagram of a call verification system, according to an embodiment;

FIG. 4 is a first flowchart for a method of caller verification, according to an embodiment.

FIG. 5 is a system diagram illustrating interception of a call setup request, according to an embodiment.

FIG. 6 is a system diagram illustrating one embodiment of basis to determine whether a call is fraudulent, according to an embodiment.

FIG. 7 is a system diagram illustrating call verification, according to an embodiment.

FIG. 8 is a system diagram illustrating certain features of a communications infrastructure containing a mobile device and a wireline telephone, according to an embodiment.

FIG. 9 is a second flowchart for a method of caller verification, according to an embodiment.

FIG. 10 is a schematic diagram illustrating an implementation of a computing device in an example computing environment, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification, are not necessarily intended to refer to the same implementation and/or embodiment or to any one particular implementation and/or embodiment. Furthermore, it is to be understood that particular features, structures, characteristics, and/or the like described, are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides guidance regarding reasonable inferences to be drawn; however, likewise, “in this context” in general without further qualification refers at least to the context of the present patent application. As discussed herein, auditing, authorizing, and/or authentication represent possible approaches, among many possible approaches, to reduce the risk of fraud. Other approaches or portions thereof, such as identity verification, authorization, auditing and/or authorizing, or the like may also be used herein, in whole or in part, such as part of, in addition to, and/or in conjunction with auditing, authorizing, and/or authenticating a transacting party as such may be employed to prevent, or to at least reduce the incidence of, allowing fraudulent transactions to take place.

In an environment in which electronic communication devices, such as landline or wireline telephones utilizing analog voice signals, mobile cellular communications devices utilizing digitized voice signals, voice over Internet protocol (VoIP) communications devices, have become ubiquitous, a communications device user may wish to engage in a transaction (e.g., a financial transaction) utilizing such electronic communications devices. Prior to initiating an electronic transaction, a user of an electronic communications device may establish an identity, such as may be established in connection with an electronic communications device subscriber account with a cellular communications device services carrier, a carrier providing services within the public switched telephone network (PSTN), a VoIP services provider, and so forth. Establishment of an electronic communications device subscriber account can permit the identity of an individual attempting to engage in an electronic transaction to be verified, audited, authorized, and/or authenticated. Of course, given the nature of transactions, especially in an environment in which electronic transactions take place via a communications network at any time and at any location, it may be useful to be able to perform verifying, auditing, authorizing, and/or authenticating operations relatively quickly, such as in a real-time fashion or nearly so.

Accordingly, it may be appreciated that preventing fraud, such as may be attempted utilizing electronic communications devices, may be an active area of investigation. Approaches toward fraud prevention may rely on manual fraud detection and/or prevention, for example, by asking a series of specific, personal questions to a user of an electronic communications device, which may permit an individual to prove their identity, such as, for example, by appropriately answering one or more questions pertaining to, for example, a maiden name of a parent, a favorite school mascot, a first concert attended, the make/model of a vehicle purchased long ago, and so forth. However, in some instances, such querying/answering may consume an inordinate amount of time, such as 90 seconds for each telephone call received by a telephone call center. In some call center environments, extension of a telephone call received by call-center personnel, which may consume an average of 30 seconds, may incur an additional and unnecessary cost burden of, perhaps millions of dollars per year. For example, a call center staffed by 500 persons, in which 30 seconds of every received call is consumed by verifying, authenticating, auditing, and/or authorizing each individual caller, may incur an additional payroll cost of, for example, $1.5 million per year or more. Further, as verbal identification of a third-party becomes more and more complicated, such per-caller cost burdens can be expected to increase. Further, in addition to such time burdens placed on call center personnel, each individual caller must be capable of reciting an increasing number of specific personal details in order to engage in any transaction, even if such transactions involve relatively insignificant funds.

In some instances, attempts to verify the identity of callers (such as callers calling via telephone or other type of electronic communications device utilizing voice and/or data signals) attempting to engage in an electronic transaction may utilize methods that involve testing of the probability that the telephone associated with the calling party is in use but without knowledge, at least with an acceptable degree of certainty, that, in fact, the telephone circuit or other type of communications channel is, in fact, engaged in a telephone call. For example, some telephone communication systems may utilize audio cues, which, while the call is in progress, may operate to determine if the communications channel between the call source and the call destination meets a statistical model of the correct calling telephone. In another example, an electronic communication system may attempt to call the telephone number of the purported call source to determine if the electronic communication system registers a “busy” signal. However, such approaches may only provide an indication that a call source is active (e.g., the call source is “off the hook”) but without establishing that the call source is currently engaged in a call to a call center. Accordingly, such techniques may fall short in verifying, authenticating, auditing, and/or authorizing, with an appropriate degree of certainty, a call source purportedly engaged in a telephone call to a call center.

In another instance, to determine with an appropriate degree of certainty whether a conversation with a call center is in progress, communication circuits and/or other types of communications channel resources of an electronic communications device subscriber network involved in the call may be examined and/or or probed to determine if the communications channel is connected or coupled between or among two or more physical devices. Such techniques may be referred to as call tracing. However, call tracing may, at times, represent a prohibitively slow process, which, in some instances, may be prohibited by local laws.

As a general matter, auditing, authorizing, and/or authenticating of a transacting party, such as mobile authentication, may be desirable in response to an institution or organization (e.g., third party, etc.) wishing to verify or audit, authorize, and/or authenticate the identity of a transacting party (e.g., mobile subscriber). Auditing, authorizing, and/or authenticating may involve establishing a correspondence and/or association of a transacting party with a persistent mobile communications device identifier, as demonstrated below through illustrative examples. In this context, a correspondence, association, and/or similar terms, refers to a persistent, continuing and objectively verifiable relationship between a transacting party with and a particular mobile communications device. Thus, a mobile communications device identifier may be employed to signify a particular party attempting to initiate and/or engage in a transaction. The term mobile communications device identity and/or similar terms in this context refers to an identity that relies on a mobile communications device account relationship (also referred to as a correspondence and/or association) of a user as a source of auditing, authorizing and/or authenticating a transacting party and is capable of being verified by another (e.g., a third-party auditing, authorizing and/or authenticating entity).

The term mobile communications device account and/or similar terms in this context refer to a mobile services provider account. Likewise, the terms “mobile communications device services provider,” “mobile communications device carrier,” “mobile network operator” may be used interchangeably. Also, in this context, the term “wireless carrier,” “common carrier,” or simply “carrier” refers to an entity in a telecommunications infrastructure that provides wired and/or wireless communication services to the general public for a consideration, such as a fee. Also in this context, the term “telephone” refers to a predominantly electrical device to convert acoustic signals to analog voice signals or may refer to any other type of electronic communications device utilizing voice and/or data signals to convey voice information and/or was parameters. While a carrier may comprise a mobile communications device services provider and/or mobile network operator; there are examples of carriers that are not mobile communications device services providers and/or mobile network operators. Such examples may include wireline services providers (for example, such as within the public switched telephone network or PSTN) providing services for rotary dial telephones and/or telephones utilizing dual tone multi-frequency (DTMF) signaling. Accordingly, the term “carrier” may be used in place of mobile communications device services provider and/or wireline telephone services provider without a loss in meaning and/or understanding. In any given situation, particular context of usage should indicate if carrier is being used in its most general sense or in a narrow sense, such as referring to a mobile communications device services provider, wireline services provider, and/or mobile network operator, for example.

It is noted that while a correspondence or association between transacting party and a mobile communications device need not be permanent, such correspondence or association between a transacting party and a mobile communications device should imply some amount of persistence to be of use in this context. Other aspects of auditing, authorizing, and/or authentication are described in greater detail later. As noted, in an embodiment, auditing, authorizing, and authenticating a transacting party, may relate to a mobile account and/or a mobile subscriber, for example. As mentioned, a mobile account is one example of a type of account, especially in a networked electronic commerce environment, although claimed subject matter is not intended to be limited to online accounts or mobile accounts. Rather, the term “account” in this context refers to a formal business arrangement between an entity, person, or other type of transacting party, and a provider of the account in order to accomplish a business purpose. It is noted, for purposes of clarification, that in some situations, a person may represent an entity, for example. The term “account” is intended to be broadly interpreted and may include a service account, a financial account, an account relating to access to content, as just a few illustrative examples. Thus, continuing with non-limiting examples, an account, in various embodiments, may, for example, be employed with respect to purchase of goods and/or services, access to content, access to financial accounts, access to medical records, access to corporate or organizational intellectual property and/or other types of records and/or files, access to other services, etc.

Likewise, an account may comprise attributes associated with or corresponding to the account. In this context, the term attribute refers to a specific quality or feature associated with the account that at least in part defines aspects of the account. Examples, again, as non-limiting illustrations, may include: an account number, an owner of the account and/or other attributes that potentially may differ based at least in part on the type of account. For example, as non-limiting illustrations, with respect to a mobile communications device account, examples of attributes may include: (1) an identifier of a mobile subscriber account with a mobile communications device services provider, (2) a mobile subscriber unique alias, (3) a mobile telephone number, (4) a mobile subscriber service provider; and/or (5) an international mobile subscriber identifier (IMSI), Integrated Circuit Card Identifier (ICC ID) and/or similar identifier employed in connection with the particular mobile network operator or the mobile communications device services provider, in this example, a GSM compatible and/or compliant telecommunications network. Other examples of attributes may comprise an international mobile equipment identifier (IMEI), a mobile equipment identifier and/or other identifiers in addition, such as a mobile subscriber account number/identifier and/or billing account number/identifier. Furthermore, again, providing additional non-limiting illustrations, a database may include other attributes, such as past transaction related attribute records, including, as non-limiting examples, merchants and/or other third party requesters, dates, description of transactions completed, and/or also may include change events, such as associated with one or more of the following, for example: (1) mobile communications device services provider, (2) IMSI (or other subscriber ID), (3) IMEI (or device equivalent), (4) mobile number, and/or (5) network status.

Some example methods, apparatuses, and/or articles of manufacture are disclosed herein that may be used, in whole or in part, to facilitate and/or support one or more operations and/or techniques for Trust Portal electronic infrastructure, such as implemented in connection with a processor-equipped cellular mobile communications device (which may be referred to herein as a “mobile communications device”) communicating with one or more computing devices via the one or more communication networks utilizing one or more communications protocols (e.g., network protocols, etc.) discussed herein. The mobile communications device may be utilized to authorize a transacting party, and/or authenticate a transacting party, so as to permit a particular electronic or on-line transaction to take place. Such electronic or on-line transactions, which may herein be referred to as simply “transactions,” may involve transactions related to one or more financial accounts, such as accounts that relate to a line of credit, a mobile communication services account, a bank account, or the like. In this context, a “transacting party” refers to an entity, such as an individual subscriber, who may attempt to engage in and/or facilitate an electronic or on-line transaction.

As will be seen, in some instances, one or more operations and/or techniques may be utilized in systems and methods for caller verification may be implemented to determine the occurrence of one or more deterministic events with respect to, or within the context of, operation of a mobile communications device owned, or at least associated with, a transacting party. Such deterministic events may include, but are not limited to, porting of a telephone number between a first mobile communications device carrier to a second mobile communications device carrier, replacing a subscriber identity module (SIM) of a mobile communications device, purchasing (or otherwise obtaining) a new, previously unused mobile communications device, and changing or updating a password. Occurrence of certain deterministic events within an electronic infrastructure may be considered in selecting, such as by way of a computing device, whether an electronic or on-line transaction should be permitted to occur.

Within the context of electronic or on-line transactions, behaviors of an individual subscriber, as such behaviors relate to the subscriber's mobile communications device, may be considered in a decision to approve, or to deny, a transaction. Behaviors exhibited by an individual mobile communications device subscriber may be referred to as “subscriber-specific” behaviors. As will be described further herein, occurrence of one or more deterministic events, within the context of a subscriber's mobile communications device, may be considered within the additional context of one or more subscriber-specific behaviors. In one example, as will be described herein, an occurrence of a deterministic event, such as porting of a telephone number of a mobile communications device from a first mobile communications device carrier to a second mobile communications device carrier may be viewed as an event that may degrade a subscriber's trustworthiness score or other type of confidence metric. In another example, an occurrence of a deterministic event related to a subscriber's replacing a subscriber identity module (SIM) of his or her mobile communications device may also be viewed as an event that may degrade a subscriber's trustworthiness score or other type of confidence metric. In another example, a subscriber's recent replacement of a mobile communications device (such as with a previously unused mobile communications device) may also be viewed as an event that may degrade a subscriber's trustworthiness score or other type of confidence metric. In another example, a subscriber's recent resetting of a password, such as a password that may be utilized to obtain access to an online bank account may also be viewed as an event that may degrade a subscriber's trustworthiness score or other type of confidence metric. Other types of deterministic events may also be viewed as events that degrade a subscriber's trustworthiness score or other type of confidence metric, and claimed subject matter is not limited in this respect.

As is also discussed below, one or more systems and methods for call verification and behavioral analysis may allow a particular institution or organization, such as a bank, a retailer, a broker, an automobile dealer, just to illustrate possible examples, to verify, authenticate, audit, and/or authorize communication services subscriber (or other caller) so that a transaction may be permitted to take place. Depending on an implementation, caller verification and behavioral analysis may be utilized to permit a more accurate approach toward verification, authentication, auditing, and/or authorizing of an individual calling to request approval of a transaction. Accordingly, transactions that may otherwise be denied may be approved in view of increased accuracy with respect to verifying, authenticating, auditing, and/or authorizing a calling individual. Conversely, under certain circumstances, potentially fraudulent transactions, which may otherwise be approved, may be denied in view of increased accuracy brought about by caller verification and behavioral analysis.

Also in this context, the term “resource,” such as referred to within the context of a “signaling resource,” refers to one or more computing resources (including virtual and/or session-related resources). The term “resource” also includes one or more physical circuits, such as may be utilized to setup or to form a communications channel, such as, for example, may be formed during a setup process performed in a wireline telephone network, such as the public switched telephone network (PSTN) or other type of circuit-switched telephone network. The term “resource” also refers to a wireless communications channel, which may include one or more subchannels, subbands, etc., assigned in a frequency space. The term “resource” also refers to a time slot, such as may be assigned by a wireless fidelity (Wi-Fi) router or as may be assigned in a wireless local area network (WLAN). It should be noted that the term “resource” also refers to any combination of the above-identified timeslots, frequency channels/subchannels, virtual or session-related computing resources, and physical circuits.

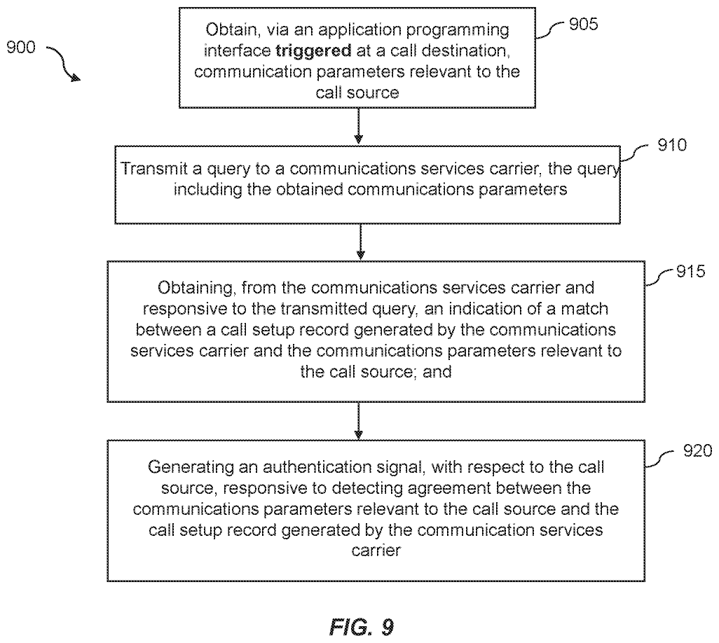

A resource also refers to, sub channel or sub band, time slot, or other type of utility of a wireless communications network, such as those described in reference to FIG. 9, described herein. The term resource also refers to a virtual communications channel, virtual processing resource, virtual sessions, or the like.

Although the discussion that follows relates to any type of subscriber communication services account, as a non-limiting illustration, mobile accounts are used for illustration. It is understood, of course, that claimed subject matter is intended to not be limited to examples provided primarily for purposes of illustration, since such examples may be oversimplified for purposes of comprehension, for example. As was mentioned previously, with respect to commerce, including, of course, mobile accounts, a risk of fraud and/or unauthorized actions taking place is present.

The following provides a few illustrative examples of accounts in which a risk of fraud and/or unauthorized actions may exist. A calling party (e.g., a call source) may attempt to access a bank account via a web browser or an executable application on a mobile communications device, for example. Thus, a bank, lender, brokerage firm, or any other type of financial institution, in response to the attempt to access the bank account, may employ an application programming interface (API) substantially compatible and/or substantially compliant with HTTP and/or HTTPS, including versions now known and/or to be later developed, and/or another suitable protocol (e.g., now known and/or to later be developed). In the foregoing example, a user may seek to take one or more actions with respect to an account, such as, for example, establishing an account, transferring funds, viewing a history of transactions, making a payment, updating personal content, etc.

Thus, as suggested, a user (e.g. a caller at a call source) may seek to access an online account. A third party, such as those who may provide such an account, may seek to protect access appropriately at least in part for reasons of confidentiality. In an example, a software company and/or product, such as a developer of tax-preparation software products, may have a user account established. One may also consider similar variations in which confidentiality may not be an aspect. For example, for premium content management, a user may seek to access content because he or she has an online subscription to a major newspaper. In another variation, a user may desire to access content, whether such content corresponds to personalized content (e.g., of a social media network) or does not correspond to personalized content, such as premium sports-related content. In another scenario, a user could be returning to a website and/or application, and the website or application could be dependent at least in part on binding a user with a website and/or with an application, such as via an account for the user. As another example, a user may ‘click’ a ‘click-to-call’ button of a website and/or application to reach customer care. Thus, a third party may comprise a customer care facility of an enterprise, for example, such as a care facility of a bank, in which an account is established. Yet another scenario may involve confidentiality associated with medical records of patients, such as compliance with HIPAA, the Affordable Care Act, Electronic Medical Records, and/or other regulatory schemes. A variety of potential situations may arise in which a user may seek access to records, such as a patient, a company, such as for insurance, as an example, a hospital, a medical professional providing care, etc. Thus, again, a user or authorized agent may log into a user's medical record account that may exist online and/or be stored electronically, such as on a website. As yet another example, a variety of corporate programs, including as examples, airline mileage accounts, gift cards, etc., in which value has been accumulated, may be managed as online accounts. Thus, all of the foregoing examples and many more accounts are subject to risk associated with fraud and/or unauthorized actions by an unscrupulous individual (e.g., “bad actor” or “meddler”).

Continuing with this example, therefore, an unscrupulous individual at a call source may desire to modify one or more attributes of a particular mobile account. For example, the unscrupulous individual may desire to create a false identity as the owner of the account. As mentioned previously, one way to handle such risks may be to employ verifying, auditing, authorizing and/or authenticating, such as may pertain to an individual associated with a mobile communications device, which may include verifying trustworthiness of a transacting party, for example, via one or more appropriate processes and/or procedures. As was also indicated, at times, such processes and/or procedures may include communicating (e.g., exchanging, etc.) content related to a particular user and/or entity (at a call source) utilizing one or more channels and/or other resources of a communications networks. For example, while transacting parties interact with an institution or organization, they may provide certain content, including personally identifiable information that can be used, at least in part, to verify their identity. Included in this content are often uniquely identifiable values that uniquely identify a person, for example, such identifiers may include but are not limited to a phone number, a Social Security number, or the like. Additionally, such an identifier may be comprised of a group of values, for example, such identifiers may include but are not limited to an address, a first name, a date of birth, or the like.

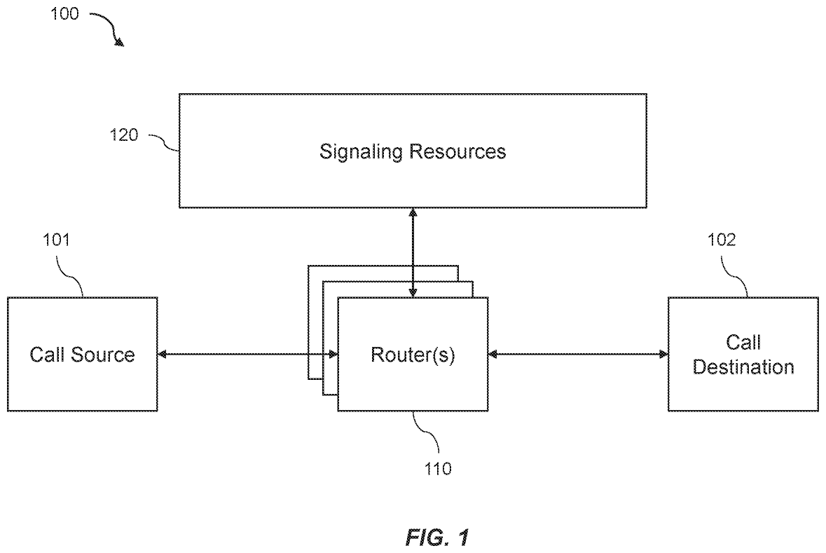

In response to currently-available electronic communications systems being vulnerable to fraudulent activity, an electronic communications system capable of verifying, auditing, authorizing, and/or authenticating, such as with an increased degree of precision, the identity of a caller can provide a basis for a wide range of fraud-prevention capabilities involving communications networks. Fraud prevention activities may extend to reducing instances of identity theft, credit fraud, enabling parental controls, and so on. These results can be achieved, according to one embodiment disclosed herein, by a call verification system 100, as shown and described in reference to the top-level block diagram illustrating a call verification system according to the embodiment shown in FIG. 1.

The call verification system 100 of FIG. 1 provides an approach to determining that a call is in-progress, such as between an call source 101 and a call destination 102. As previously discussed, approximately 30-90 seconds of every telephone call received by a call center may be consumed confirming the identity of the individual at call source 101. The call verification system 100 is capable of reducing or even eliminating this time as the identity of the call source 101 can be uniquely confirmed in the background of the call. This can represent significant annual savings for a call center.

FIG. 1 illustrates a simplified block diagram for outlining the flow of communication parameters during a setup of a communications channel between a call source 101 and call destination 102. As shown, call verification system 100 routes the call from call source 101 to call destination 102 through one or more routers 110, such as one or more voice routing boxes of an individual carrier operating within the public switched telephone network (PSTN), to form a physical circuit resource that is capable of conveying voice signals between call source 101 and call destination 102. In other embodiments, call setup utilizing call verification system 100 may involve establishing other types of resources, such as wireless communications resources, to bring about communications between call source 101 and call destination 102. Such resources may correspond to frequency bands/sub bands and/or arrangement of transmit/receive timeslots of communications frames, for example, which may be utilized in wireless cellular communications systems. Accordingly, routers 110 maintain a record (not shown) that may include phone numbers/accounts/users that are connected and/or controlled by the carrier operating within a wireless or wireline communications infrastructure. In the embodiment of FIG. 1, routers 110 cooperate with one or more application-layer signaling resources 120. The signaling resources 120 enable the exchange of control information associated with the setup and release of a telephone call on a telecommunications circuit. By way of example, control parameters that may be utilized by signaling resources 120 can include digits dialed by a caller at call source 101, a logical address of call destination 102 (e.g., entered by the caller at the call source 101), selection of real-time streaming protocols between call source 101 and call destination 102, billing parameters associated with source 101, account information, and so on. It should be noted that call source 101 and call destination 102 may utilize any suitable voice and/or data communications device, such as a wireline telephone, a mobile communications device, or any other type of electronic communications device utilizing encoding and decoding voice and/or data signals.

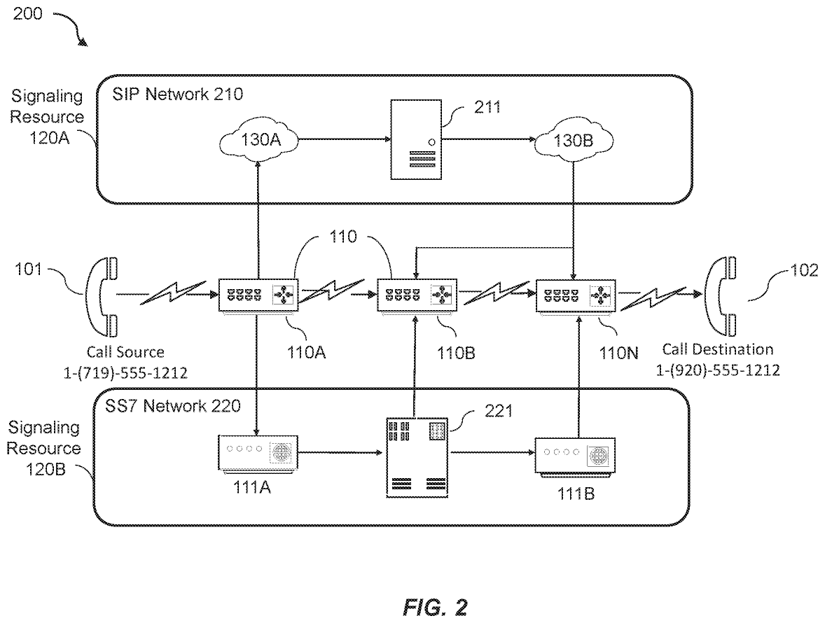

FIG. 2 is a top-level block diagram illustrating a call verification system, according to an embodiment 200. In FIG. 2, the signaling resources 120A/120B may comprise, for example, session initiation protocol (SIP) network 210 and/or a Signaling System No. 7 (SS7) network 220 based, at least in part, on the type of communications channel to be established between call source 101 and call destination 102. SIP network 210 may comprise a SIP management server 211, which may operate, via internal networks 130A and 130B, to manage encrypted SIP signaling protocol (involving asymmetric encryption keys at lengths of up to 4096 binary digits) for initiating, maintaining, and terminating real-time sessions that can include full-duplex streaming voice, video, and messaging applications. The SIP network 210 may support the SIP protocol for signaling and controlling multimedia communication sessions in applications of Internet-based telephones for voice and video calls, VoIP-based telephone systems, instant messages over IP networks, and mobile telephone communications. Additionally, SIP network 210 may involve a layer of security in which particular logical addresses, such as described in an HTTP header, may be designated as being “trusted” while other logical addresses may be designated as not being trusted.

SS7 network 220 of FIG. 2 may support the SS7 telephony signaling protocols over the PSTN. Similar to the SIP network 210, the SS7 network 220 may also comprise one or more of SS7 management server 221 for supporting number translation, local number portability, prepaid billing, short message service (SMS), and so on. SS7 network 220 may be referred to as a trust-based network, in which security layers, such as the previously-described security layer utilized in SIP network 210, are not employed. Rather, security of SS7 network 220 may rely, at least to a considerable degree, on controlling access to network 220 at the periphery of the network. Accordingly, following obtaining access to SS7 network 220, SS7 management server 221, signal router 111A, and signal router 111B may respond to any queries originating from within SS7 network 220. It should be noted that although FIG. 2 specifically identifies SIP network 210 and SS7 network 220, claimed subject matter is intended to embrace other types of signaling systems, either presently available or to be developed at a later date.

Operation of the call verification system of FIG. 2 may be initiated responsive to a user, such as at call source 101, dialing a series of telephone numbers utilizing a wireless mobile device coupled to a cellular network or utilizing a wireline (fixed) telephone device coupled to the PSTN. In particular embodiments, dialing a series of telephone numbers may bring about a dual-tone multi-frequency signaling (DTMF) signal that can be sent across a telephone network. In other embodiments, in lieu of dialing a series of telephone numbers, a user at call source 101 may enter a logical address for call destination 102.

In certain embodiments, responsive to generation of a DTMF signal at call source 101, a first voice router 110A translates the DTMF signal for use by SIP management server 211. In particular embodiments, first voice router 110A generates a SIP setup request over SIP internal network 130A to the SIP management server 211. The SIP request represents an invitation request that can be transmitted to a proxy server (not shown) and may be utilized to initiate a telephone call session. A SIP request may additionally operate to initiate an address lookup of the call destination 102 in a location server (not shown). In some instances, the proxy server may respond in a manner that informs a user at call source 101 of attempts to execute the call. Responsive to notification of attempts to execute an initiated call, the communications device at call source 101 may refrain from transmitting additional requests to SIP network 210 to initiate a calling session.

After obtaining the logical address or other type of address of call destination 102, the SIP management server 211 may form a communications channel from call source 101 to an address corresponding to call destination 102 utilizing one or more of routers 110 (e.g., 110A, 110B, . . . , 110N). SIP management server 211 designates selected routers 110 (e.g., 110A, 110B, . . . , 110N) for a circuit hop. Communications between a call source 101 and call destination 102 may then be conducted utilizing a communications channel formed by one or more of routers 110 as arranged by SIP management server 211. Additional information regarding the SIP network and related call routing can be found in the Internet Engineering Task Force's Request For Comments (RFC) RFC-3261 SIP: Session Initiation Protocol, Rosenberg et al., June 2002, available at https://www.ietf.org/rfc/rfc3261.txt.

Additionally and/or alternatively, responsive to initiation of a telephone call between call source 101 and call destination 102 utilizing SS7 network 220, first voice router 110A may generate a setup request to SS7 management server 221, for example, using a routing modem (not shown). In response to the route being generated, SS7 management server 221 forms a communications channel between call source 101 and call destination 102 via one or more routers 110 (e.g., 110A, 110B, . . . , 110N). In particular embodiments, setup requests between call source 101 and call destination 102 utilizing SS7 network 220, as well as SIP requests utilizing SIP network 120, occur prior to initiation of a telephone conversation between the call source 101 and call destination 102. Setup requests between call source 101 and call destination 102 may additionally bring about management and/or maintenance of the wireless or wireline channel formed between call source 101 and call destination 102.

As discussed above, in some embodiments, call destination 102 may obtain parameters relevant to the initiating communications device at, or accessed by, call source 101. For example, descriptive parameters, such as caller identification (ID) parameters, can be utilized to determine the identity of a user at or accessible to call source 101. Specifically, responsive to initiation of as described herein, first voice router 110A may generate parameters that may be transmitted to the receiving device at call destination 102. Transmitted parameters may comprise any parameters relevant to call source 101, such as, for example, a phone number of call source 101. However, as previously alluded to, in particular instances, a voice router (e.g., voice router 110A) may replace actual descriptive parameters (e.g., caller identification parameters) with incorrect, inaccurate, and/or fraudulent parameters. In such instances, the actual phone number corresponding to call source 101 may not be transmitted to call destination 102. Instead, a fraudulent telephone number, such as a telephone number that does not correspond to call source 101, may be transmitted to call destination 102.

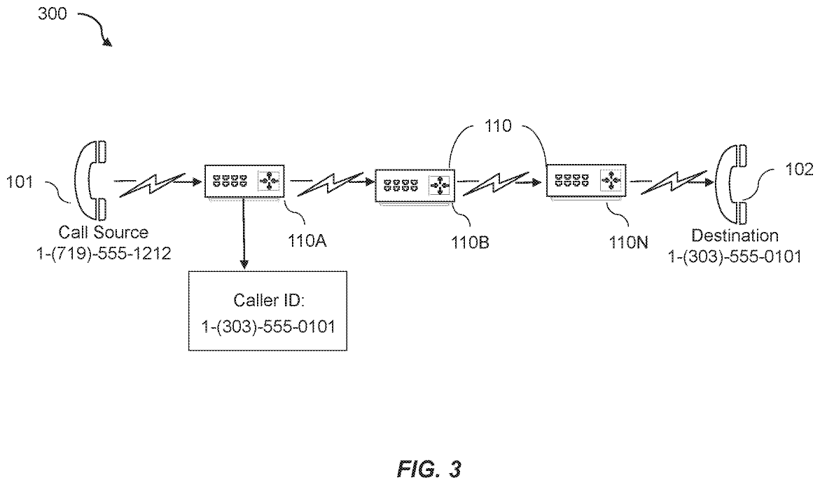

FIG. 3 is a system diagram of a call verification system, according to an embodiment 300. As depicted in FIG. 3, call source 101 has been identified utilizing unique descriptive parameters, which, in this instance, correspond to a telephone number of 1-(719)-555-1212. In other embodiments, the call source 101 may be allocated a different type of descriptive parameter, such as a telephone number having a different number structure. For example, descriptive parameters describing a non-US telephone number may begin with a country code, followed by any combination of digits (of any length) to indicate a particular state or province, a particular locality within a state or province, as well as a particular device within a particular locality. Accordingly, although call source 101 has been assigned descriptive parameters comprising a 10-digit number, having a prefix of a “1” to indicate a US-based telephone number, any combination of alphanumeric descriptive parameters may be utilized to uniquely identify call source 101. Further, call source 101 may be uniquely identified utilizing alphabetical descriptive parameters, such as a uniform resource locator (URL) an electronic mail address, and so forth.

As previously described in reference to FIG. 2, in particular instances, a voice router (e.g., voice router 110A) may replace descriptive parameters (e.g., caller ID parameters) of call source 101 with incorrect, inaccurate, and/or fraudulent descriptive parameters. Replacement of descriptive parameters may be accomplished by inserting fraudulent call parameters, such as caller ID or automatic numbering identification, via accessing one or more of voice routers 110A. Thus, as depicted in FIG. 3, descriptive parameters corresponding to caller identification numbers (e.g., 1-(719)-555-1212) may be replaced, via obtaining access to voice router 110A, to correspond to different descriptive parameters, such as a caller identification number of 1-(303)-555-0101. Accordingly, when a caller identification feature is implemented or accessed at call destination 102, such identification would indicate the incorrect, inaccurate, and/or fraudulent caller identification parameters of 1-(303)-555-0101. It should be noted that voice router 110A may make other types of modifications to descriptive parameters corresponding to call source 101, and claimed subject matter is intended to embrace all such modifications. For example, if descriptive parameters of call source 101 corresponds to an electronic mail address of Person@realphone.com, voice router 110A may, for example, substitute such descriptive parameters to correspond to, for example, Imposter@realphone.com. In another example, if descriptive parameters of call source 101 correspond to a URL of Person.realphone.com, voice router 110A may, for example, substitute such descriptive parameters to correspond to Imposterrealphone.com.

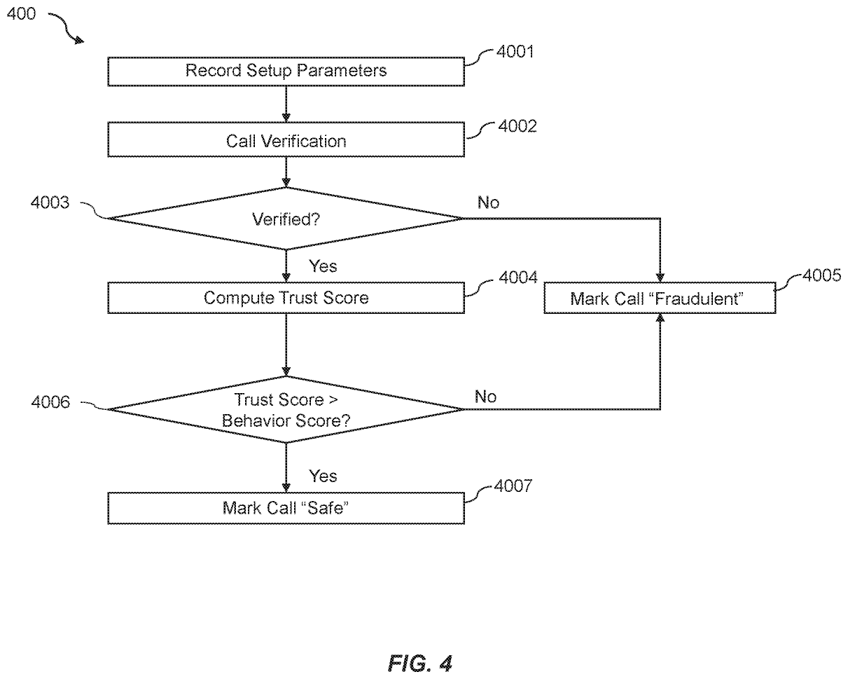

FIG. 4 is a system diagram of a call verification system, in which a trustworthiness score may be generated, according to an embodiment 400. Embodiment 400 operates to implement proof of possession of a wireless or wireline communications device (e.g., call source 101), as well as implementing proof of behavior with respect to the wireless or wireline communications device. It should be noted that the disclosed embodiments, such as that of FIG. 4, are intended to embrace variations of the respective figures, including methods that may include actions in addition to those depicted in the figures, actions performed in an order different than those depicted in the figures, as well as methods including fewer steps than those depicted. The method of FIG. 4 begins at 4001, which may include recording setup parameters, at 4001. As previously described herein, call setup may involve formation of a communications channel between a call source (e.g., call source 101) and the call destination (e.g., call destination 102). Also as previously described herein, call setup may involve formation of a wireline circuit via the PSTN and/or may involve formation of a communications channel utilizing wireless communication links. Accordingly, in response to formation of a communications channel between a call source and a call destination, setup parameters, such as voice routers employed to convey voice signals between a call source and a call destination, selected wireless and/or wireline communications protocols, session parameters, etc., may be recorded at 4001. Call setup may take place within a SIP network, such as SIP network 210, or may take place within a SS7 network, such as SS7 network 220. In particular embodiments, call setup may take place within signaling networks capable of conducting an information exchange relevant to the establishment, control, and/or maintenance of a telecommunications circuit or channel other than SIP or SS7 networks, and claimed subject matter is intended to embrace all such signaling networks, either presently available or to be developed and/or implemented at a later date.

Recording at 4001 may occur at, or may be under the exclusive control of, a carrier providing communication services to call source 101. Further, such recording may involve recording of setup parameters to a cache memory, in which setup parameters are not written to persistent memory, such as a computer disk, flash memory, and so forth. In some instances, refraining from storage of call setup parameters in a persistent memory may be beneficial in that such storage may avoid transfer-of-control restrictions implemented to maintain privacy of call parameters initiated at a call source.

4002 includes call verification, in which a call destination, such as call destination 102 as previously described herein, may utilize a specialized API to transmit a query comprising one or more descriptive parameters to a carrier providing communication services to call source 101. In particular embodiments, such descriptive parameters may include a telephone number reported by a signaling network (e.g., SIP network 210, SS7 network 220, or any other type of signaling network) to the carrier providing communication services to call source 101. Responsive to receipt of such descriptive parameters (e.g., a reported telephone number), the carrier may compare descriptive parameters to parameters utilized to form a communications channel between call source 101 and call destination 102. In certain embodiments, 4002 may involve comparison of additional descriptive parameters transmitted by call destination 102 such as a time of day at which call destination 102 received a call from call source 101, and claimed subject matter is intended to embrace all such additional descriptive parameters.

In certain embodiments, 4003 may include determining if a match exists between descriptive parameters transmitted by call destination 102 and parameters utilized to form a communications channel between a call source and the call destination. Call verification of 4003 may correspond to a process in which a call to a call destination can be verified and/or authenticated to confirm that the given originating number (e.g., of call source 101) is actually part of a “call-in-progress” with the destination number of call destination 102. 4003 may thus include a verification that a caller accessing call source 101 is, indeed, in possession of a communications device for which a communications channel between the call source and the call destination has been established. Responsive to a positive outcome of 4003, the method of FIG. 4 may then proceed to 4004.

A trustworthiness score may be computed at 4004. In particular embodiments, computing a trustworthiness score may involve accessing a database storing historical records of behavior events that pertain to an electronic communications device of a verified caller at call source 101. A historical record of behavior events may be utilized to determine a trustworthiness score or other type of confidence metric that corresponds to a caller at call source 101. For example, after verification (e.g., at 4003) that the caller at call source 101 is in possession of a mobile device that has been utilized by the same user for a number of years, a trustworthiness score/confidence metric may be increased. In certain embodiments, additional factors may increase a trustworthiness score/confidence metric, such as whether the communications device at call source 101 has recently been ported from a first telecommunication services provider to a second telecommunication services provider. Other factors that may increase a trustworthiness score/confidence metric may relate to whether the communications device at the call source 101 has recently undergone a replacement of a SIM or whether the communications device at the call source 101 has recently been purchased or whether the device has undergone some other type of transfer of ownership. Another factor that may increase a trustworthiness score/confidence metric may relate to whether a user at call source 101 has recently changed or updated a password, such as a password that may be utilized to obtain access to funds held by a financial institution. Other deterministic events may be considered in computing a trustworthiness score at 4004, and claimed subject matter is not limited in this respect.

Returning to the verification at 4003, in response to a negative outcome of such verification, which may indicate that a caller accessing call source 101 is not in possession of a communications device for which a communications channel between the call source and destination has been established, the call may be marked as fraudulent at 4005. In certain embodiments, detection of such fraudulent events may occur in response to an unscrupulous individual, for example, inserting erroneous, incorrect, and/or fraudulent descriptive parameters at a location between a call source 101 and call destination 102. In some instances, such fraudulent parameters may be inserted at a first voice router, such as voice router 110A depicted in FIG. 3. It should be noted, however, that fraudulent descriptive parameters may be inserted at other locations of a communications channel between a call source and the call destination, and claimed subject matter is not limited in this respect. It should further be noted that parameters utilized to form a communications channel between a call source and the call destination, such as a channel formed by SIP network 210 or by SS7 network 220 (or other suitable signaling network currently implemented or to be implemented at a later date), may be difficult to interfere with or to corrupt. In particular embodiments, such as embodiments in which call setup is performed by SIP network 210, such difficulty in corrupting or interfering with call setup parameters may stem from the presence of one or more security layers utilized within SIP network 210. In other embodiments, such as embodiments in which call setup is performed by SS7 network 220, such difficulty in corrupting or interfering with call setup parameters may stem from controlling access to network 220 at the periphery or boundary of the network.

Thus, the method of the embodiment of FIG. 4 substantially increases the difficulty in inserting fraudulent parameters during call setup operations performed by SIP network 210 or SS7 network 220. If fraudulent parameters were to be inserted into SIP network 210 or SS7 network 220, a communications channel would be formed between a call source 101 and a call destination other than call destination 102. Accordingly, responsive to insertion of fraudulent parameters during call setup, a caller at call source 101 attempting to fraudulently engage in a bank transaction by contacting a bank officer at a call destination could possibly find himself/herself in communication with an individual at a call destination that has no affiliation with any financial institution.

Returning briefly to 4004, in which a trustworthiness score or other type of confidence metric is computed, the method may continue at 4005, in which the trustworthiness score or other type of confidence metric may be compared with a threshold score. Responsive to a trustworthiness score or other type of confidence metric being less than a threshold score, the method may proceed to 4005, at which the call may be marked as fraudulent. In particular embodiments, a trustworthiness score/confidence metric may be computed responsive to a caller, such as a caller at call source 101, subjecting a mobile communications device, for example, to risk-associated events. Such events may include recent porting of a phone number from a first carrier to a second carrier, removal/replacement of a SIM of a mobile device, recent use of the one-time password to reset an email account, bank account, or other type of account, recent purchase of a new or previously-unused mobile communications device, among other events. Accordingly, responsive to a user engaging in one or more of these events, a trustworthiness score, for example, may be degraded. Responsive to a trustworthiness score/confidence metric falling below a predetermined threshold score, such as may be predetermined by a bank or other institution as being required in order to engage in a certain type of financial transaction, for example, a transaction may be marked as fraudulent (4005).

Conversely, responsive to a user engaging in very few or no risk-associated behaviors, a behavior score may be enhanced or increased. Responsive to a trustworthiness score or other type of confidence metric comprising a value above a threshold score, such as may be predetermined by a bank or other institution as being required in order to engage in a certain type of financial transaction, for example, a call may be indicated as being “safe” as in 4007.

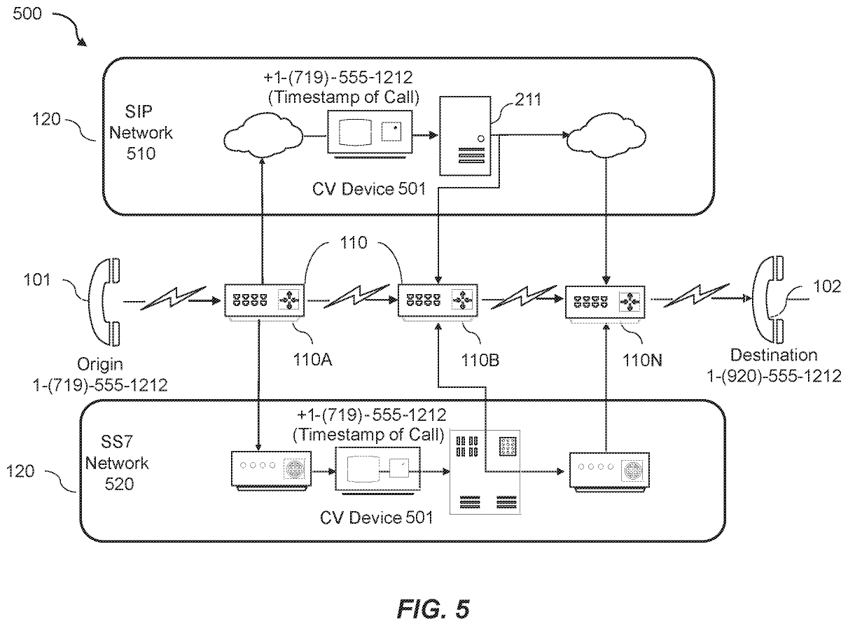

FIG. 5 is a system diagram illustrating interception of a call setup request, according to an embodiment (500). Embodiment 500 of FIG. 5 differs somewhat from the embodiment of FIG. 2 in that the system diagram of FIG. 5 includes call verification (CV) devices 501, which operate to store, such as in a cache memory, call setup parameters for a telephone call between call source 101 and call destination 102. As previously described herein, setup may involve formation of a communications channel between a call source (e.g., call source 101) and the call destination (e.g., call destination 102). Call verification devices of SIP network 510 and of SS7 network 520 may operate to compare parameters provided by, for example, an API operating at, or accessible to, call destination 102. In particular embodiments, call verification devices 501 may operate to compare call setup parameters for a telephone call between call source 101 and call destination 102 with one or more descriptive parameters provided by an API operating at, or accessible to, call destination 102. Accordingly, in the embodiment of FIG. 5, responsive to determining a match between call setup parameters generated by SIP network 510/SS7 network 520 and descriptive parameters provided by call destination 102, a determination may be made that a caller at call source 101 represents a legitimate caller. Responsive to a mismatch between the call setup parameters generated by SIP network 510/SS7 network 520 and descriptive call parameters provided by call destination 102, a determination may be made that a caller at call source 101 represents a fraudulent caller. It should be noted that although FIG. 5 specifically identifies SIP network 510 and SS7 network 520, claimed subject matter is intended to embrace other types of signaling systems or networks capable of conducting an information exchange that may enable the establishment, control, and/or maintenance of a telecommunications circuit or channel, and claimed subject matter is intended to embrace all such signaling networks, either presently available or to be developed and/or implemented at a later date.

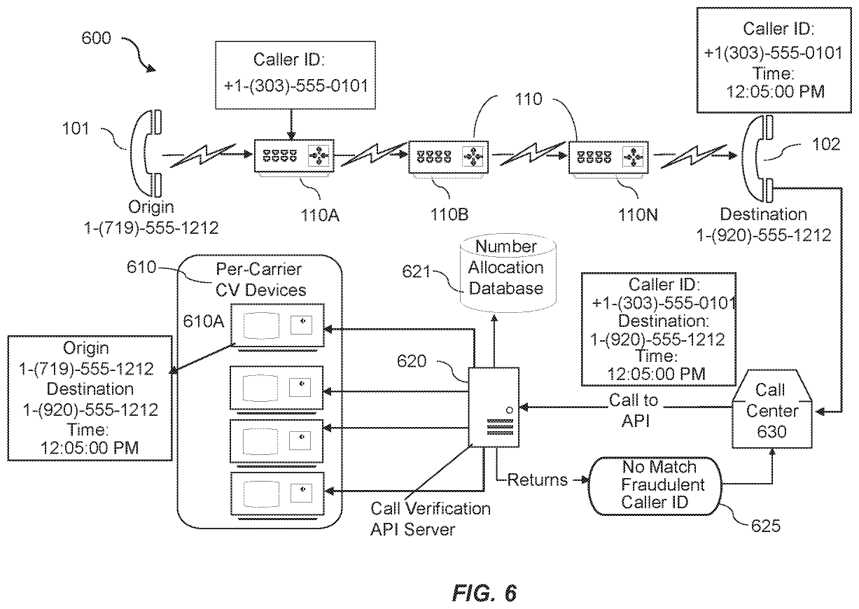

FIG. 6 is a system diagram illustrating one embodiment of a basis to determine whether a call is fraudulent, according to an embodiment 600. As depicted in FIG. 6, call source 101 corresponds to a communications device having a telephone number of, for example, 1-(719)-555-1212. A caller at call source 101 may attempt to contact a bank officer at call destination 102 within call center 630, having a telephone number corresponding to, for example, 1-(920)-555-1212. However, also as depicted in FIG. 6, an unscrupulous individual (for example) has inserted a fraudulent telephone number such as, for example, 1-(303)-555-0101. Accordingly, a communications channel may be constructed so as to route voice signals, for example, from call source 101 to call destination 102 via voice routers 110A, 110B, . . . , 110N. Responsive to such fraudulent telephone number insertion at voice router 110A, call source 101 may be identified, such as via automatic number identification and/or caller ID parameters (or other descriptive parameters) as corresponding to 1-(303)-555-0101.

At call destination 102, a call center agent may correspond to an employee at a financial institution capable of executing a financial transaction initiated by the caller at call source 101. Alternatively, call destination 102 may correspond to a computerized interactive voice response system that operates without user input. In either instance, an entity at call destination 102 may access an API at call center 630 to perform a comparison between descriptive parameters reported to call destination 102 and call setup parameters utilized to form a communications channel between call source 101 and call destination 102. Thus, in the embodiment of FIG. 6, an application program interface, invoked or accessed at call center 630, may begin a caller verification process by accessing number allocation database 621 via call verification API server 620. In particular embodiments, number allocation database 621 may correspond to a database that maps descriptive parameters (e.g., caller ID) of a call source, such as 1-(303)-555-0101 of FIG. 6 with particular carriers providing communication services. In some embodiments, a number allocation database 621 may utilize, or at least accord with, the North American Numbering Plan. Thus, a number allocation database 621 may operate to determine which carrier, of a plurality of communication services providers, has been allocated the phone number reflected in the parameters of the caller ID. The North American numbering plan, for example, may inform call verification API server 620 which of per-carrier call verification devices 610 can be queried to determine if the caller ID is involved in the call-in-progress. Such determination may be made based, at least in part, on the recorded setup request for the carrier that formed the communications channel. Thus, in the embodiment of FIG. 6, at least one of per-carrier call verification devices 610 can confirm that the received caller ID matches the communications channel routing parameters included in the setup parameters utilized to form a communications channel between call source 101 and call destination 102. It should be noted that although the North American numbering plan has been discussed (hereinabove) claimed subject matter is intended to embrace all national and/or regional numbering plans, such as numbering plans enacted by the International Telecommunication Union, for example.

Accordingly, number allocation database 621 may determine that a particular communication services carrier has been allocated the descriptive parameters (e.g., caller ID) of 1-(303)-0101) corresponding to call source 101. Call verification API server 620 may then convey the descriptive parameters reported to call destination 102 to a particular per-carrier call verification device, such as device 610A so that a comparison can be made between the descriptive parameters and call setup parameters utilized to form a communications channel between call source 101 and call destination 102. However, as shown in FIG. 6, in response to accessing call setup parameters utilized to form a communications channel between call source 101 and call destination 102, call verification API server may determine a mismatch. In the example of FIG. 6, per-carrier call verification device 610A may have no record of a call setup between a call source corresponding to 1-(303)-555-0101 and a call destination corresponding to 1-(920)-555-1212 at 12:05:00 PM. Accordingly, responsive to call setup parameters and descriptive parameters not being in agreement (or mismatched), call verification API server 620 may report an indication of a fraudulent caller ID, such as depicted at 625.

Thus, in FIG. 6, in response to call verification API server 620 querying per-carrier call verification devices 610, along with providing caller ID parameters in the query, one or more per-carrier call verification devices indicate whether a record exists of a communications channel being formed between the call source and the call destination. In addition to caller ID parameters, the query from call verification API server 620 may additionally include a time at which the particular call was answered at the call destination. Caller ID parameters included in the query may then be checked against the call setup parameters to ensure that such a call was placed—within a predetermined margin of error (e.g., a few seconds or more or less) to allow time for connection—to ensure that the call is in progress. If the setup record does not exist within a particular per-carrier call verification device (such as verification device 610A) and/or the call verification device cannot identify an existing call-in-progress, then a potential fraud state exists. An indication of such potential fraud may be indicated to the client (e.g., call center 630). Such indications may be conveyed to other computing entities, and claimed subject matter is not limited in this respect.

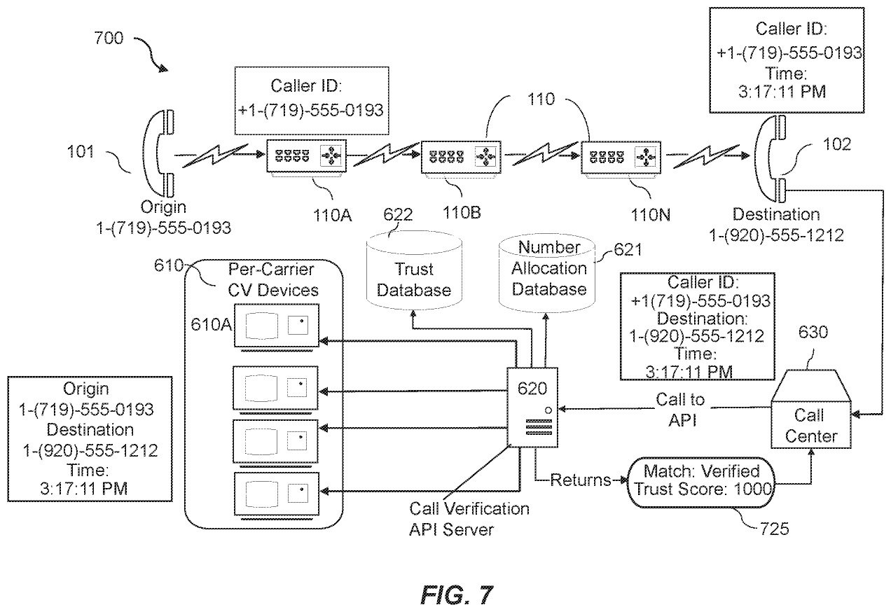

FIG. 7 is a system diagram illustrating call verification, according to an embodiment 700. As depicted in FIG. 7, call source 101 corresponds to a communications device having a telephone number of, for example, 1-(719)-555-0193. A caller at call source 101 may attempt to contact a bank officer, for example, at call center 630, having a telephone number corresponding to, for example, 1-(920)-555-1212. As is further depicted in FIG. 7, voice router 110A faithfully and/or accurately reports descriptive parameters, such as a telephone number corresponding to call source 101 (e.g., 1-(719)-555-0193). Thus, call source 101 may be correctly identified, such as via automatic number identification and/or caller ID parameters (or other descriptive parameters) as corresponding to 1-(719)-555-0193. At call destination 102, a call center agent, which may correspond to a person, or an interactive voice response computer, capable of executing a financial transaction initiated by a caller from call source 101. In response to a request to initiate a transaction from call source 101, an API accessed by call center 630 may begin a caller verification process by accessing number allocation database 621. Number allocation database 621 may determine that descriptive parameters (e.g., caller ID of 1-(719)-555-0193) of a call source 101 determines which carrier, of a plurality of communication services providers, has been allocated the phone number reflected in the parameters of the caller ID. Accordingly, call verification API server 620 may determine that per-carrier call verification device 610A can verify whether the caller ID is involved in the call-in-progress. Responsive to such determination, call verification API server 620 may transmit a query to per-carrier call verification device 610A. The query may provide descriptive parameters (e.g., caller ID of 1-(719)-555-0193) at a time of day at which destination 102 received the call. In response, per-carrier call verification device 610A may determine if the caller ID is involved in the call-in-progress. Such determination may be made based, at least in part, on the recorded setup request for the carrier that formed the communications channel between call source 101 and call destination 102. Thus, in the embodiment of FIG. 7, at least one of per-carrier call verification devices 610 (e.g., device 610A) can confirm that the received caller ID matches the communications channel routing parameters included in the setup parameters utilized to form a communications channel between call source 101 and call destination 102. Accordingly, responsive to call setup parameters and descriptive parameters being in agreement (or matched), call verification API server 620 may report an indication of a verified caller ID, such as depicted at 725.

Thus, in FIG. 7, in response to call verification API server 620 querying per-carrier call verification devices 610, along with providing caller ID parameters in the query, one or more per-carrier call verification devices indicate whether a record exists of a communications channel being formed between the call source and the call destination. In addition to caller ID parameters, the query from call verification API server 620 may additionally include a time at which the particular call was answered at the call destination. Caller ID parameters included in the query may then be checked against the call setup parameters to ensure that such a call was placed—within a predetermined margin of error (e.g., a few seconds or more or less) to allow time for connection—to ensure that the call is in progress. If the setup record exists within a particular per-carrier call verification device (such as verification device 610A), then the caller may be verified. An indication of such verification of a caller at call source 101 may be indicated to the client (e.g., call center 630). Such indications may be conveyed to other computing entities, and claimed subject matter is not limited in this respect.

FIG. 7 additionally depicts trust database 622, which, in particular embodiments, advantageously maintains a history of user activity related to the user's phone account and the user's devices, such as how long the user has been associated with the current account, how often the user changes his/her device, and/or how often the user changes SIM cards. Call verification API server 620 can also access more detailed information about the user's use of his/her phone. For example, trust database 622 may have information about the user's attempt to log into services such as banks, retailers, credit cards, payment systems, etc. By analyzing such parameters, a behavior score can be derived that articulates a measure of risk of the current transaction and/or user's account. For example, a user who keeps a mobile communications device for three years or more, seldom ports his or her number from a first carrier to a second carrier, has not recently requested a one-time password to modify account credentials, and has not replaced a SIM, may justify an increased trust score. Other deterministic events may be considered in computing a trustworthiness score of, and claimed subject matter is not limited in this respect.

Conversely, many recent changes to a user's tracked information would lower the trustworthiness score and lead to a failure to authenticate a caller at call source 101. For example, if the user recently acquired a new communications device, and/or has ported of telephone number from a first carrier to a second carrier, has recently requested a one-time password to modify account credentials, and has recently replaced a SIM may not justify a trustworthiness score that reaches a threshold score. In some instances, responsive to call verification API server 620 returning an indication of a verified caller ID, such as depicted at 725, call verification API server may consult trust database 622 to obtain an actual trustworthiness score or other type of confidence metric of a caller and call source 101.

In some embodiments, a trustworthiness score can be derived from behavior events and/or other non-behavior based characteristics indicative of a user's overall trust. Or the trustworthiness score can be derived from characteristics indicative of the trust level of a particular transaction as desired. By way of example, non-behavior characteristics might include state-based variables, line type (e.g., mobile, VoIP, landline). Behavior-based characteristics, as described above, might include device changes or SIM changes over a period. For example, a device or SIM change in the last 30-days might be indicative of risky behavior and lower a user's score accordingly. Or, as another example, three SIM changes in the last 90 days might also indicate risky behavior that would lower a user's score.

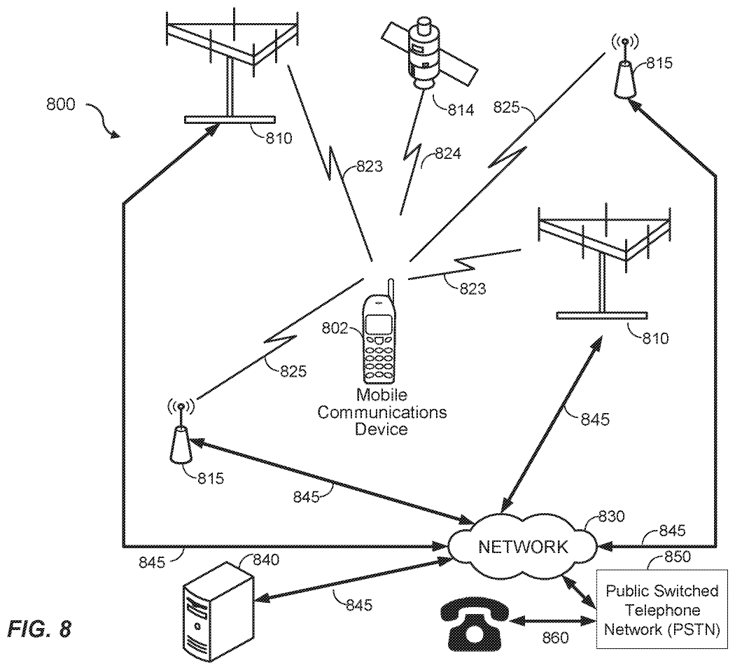

FIG. 8 is a system diagram illustrating certain features of a communications infrastructure containing a mobile device and a wireline telephone, according to an embodiment. As shown in FIG. 8 in a particular implementation, mobile device 802, which may also be referred to as a UE (or user equipment), may transmit radio signals to, and receive radio signals from, a wireless communications network. In one example, mobile device 802 may communicate with a cellular communications network by transmitting wireless signals to, and/or receiving wireless signals from, a cellular transceiver 802, which may comprise a wireless base transceiver subsystem (BTS), a Node B or an evolved NodeB (eNodeB), over wireless communication link 823. Similarly, mobile device 802 may transmit wireless signals to, and/or receive wireless signals from, local transceiver 815 over wireless communication link 825. A local transceiver 815 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network, such as those discussed in the next paragraph). Of course, it should be understood that these are merely examples of networks that may communicate with a mobile device over a wireless link, and claimed subject matter is not limited in this respect.

Examples of network technologies that may support wireless communication link 823 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3^{rd} Generation Partnership Project 2 (3GPP2). WCDMA is also part of the Universal Mobile Telecommunications System (UMTS) and may be supported by an HNB. Cellular transceivers 810 may comprise deployments of equipment providing subscriber access to a wireless telecommunication network for a service (e.g., under a service contract). Here, a cellular transceiver 810 may perform functions of a cellular base station in servicing subscriber devices within a cell determined based, at least in part, on a range at which the cellular transceiver 810 is capable of providing access service. Examples of radio technologies that may support wireless communication link 825 are IEEE 802.11, Bluetooth (BT) and LTE.

In a particular implementation, cellular transceiver 810 and local transceiver 815 may communicate with server 840, such as by way of network 830 through communication links 845. Here, network 830 may comprise any combination of wired or wireless links and may include cellular transceiver 810 and/or local transceiver 815 and/or server 840. In a particular implementation, network 830 may comprise Internet Protocol (IP) or other infrastructure capable of facilitating communication between mobile device 802 and server 840 through local transceiver 815 or cellular transceiver 810. In an embodiment, network 830 may also facilitate communication between mobile device 802, server 840 and a PSTN 850, for example through communications link 860. In another implementation, network 830 may comprise a cellular communication network infrastructure such as, for example, a base station controller or packet based or circuit based switching center (not shown) to facilitate mobile cellular communication with mobile device 802. In a particular implementation, network 830 may comprise local area network (LAN) elements such as WiFi APs, routers and bridges and may, in such an instance, comprise links to gateway elements that provide access to wide area networks such as the Internet. In other implementations, network 830 may comprise a LAN and may or may not involve access to a wide area network but may not provide any such access (if supported) to mobile device 802. In some implementations, network 830 may comprise multiple networks (e.g., one or more wireless networks and/or the Internet). In one implementation, network 830 may include one or more serving gateways or Packet Data Network gateways. In addition, one or more of server 840 may comprise an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) of network 830.

In particular embodiments, communications between mobile device 802 and cellular transmitter 810, satellite 814, local transceiver 815, and so forth may occur utilizing signals communicated across wireless communications channels. Accordingly, the term “signal” may refer to communications utilizing propagation of electromagnetic waves across wireless communications channels. Signals may be modulated to convey messages utilizing one or more techniques such as amplitude modulation, frequency modulation, binary phase shift keying (BPSK), quaternary phase shift keying (QPSK) along with numerous other modulation techniques, and claimed subject matter is not limited in this respect. Accordingly, as used herein, the term “messages” refers to parameters, such as binary signal states, which may be encoded in a signal using one or more of the above-identified modulation techniques.

In particular implementations, and as discussed below, mobile device 802 may comprise circuitry and processing resources capable of obtaining location related measurements (e.g. for signals received from GPS or other Satellite Positioning System (SPS) satellites 814), cellular transceiver 810 or local transceiver 815 and possibly computing a position fix or estimated location of mobile device 802 based on these location related measurements. In some implementations, location related measurements obtained by mobile device 802 may be transferred to a location server such as an enhanced serving mobile location center (E-SMLC) or SUPL location platform (SLP) (e.g. which may comprise a server, such as server 840) after which the location server may estimate or determine an estimated location for mobile device 802 based on the measurements. In the presently illustrated example, location related measurements obtained by mobile device 802 may include measurements of signals (824) received from satellites belonging to an SPS or Global Navigation Satellite System (GNSS) such as GPS, GLONASS, Galileo or Beidou and/or may include measurements of signals (such as 823 and/or 825) received from terrestrial transmitters fixed at known locations (e.g., such as cellular transceiver 810).

Mobile device 802 or a separate location server may obtain a location estimate for mobile device 802 based on location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at mobile device 802 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at mobile device 802. Here, server 840 may be capable of providing positioning assistance data to mobile device 802 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, server 840 may comprise an almanac to indicate locations and identities of cellular transceivers and/or local transceivers in a particular region or regions such as a particular venue, and may provide information descriptive of signals transmitted by a cellular base station or AP such as transmission power and signal timing. In the case of E-CID, a mobile device 802 may obtain measurements of signal strengths for signals received from cellular transceiver 810 and/or local transceiver 815 and/or may obtain a round trip signal propagation time (RTT) between mobile device 802 and a cellular transceiver 810 or local transceiver 815. A mobile device 802 may use these measurements together with assistance data (e.g. terrestrial almanac data or GNSS satellite data such as GNSS Almanac and/or GNSS Ephemeris information) received from server 840 to determine a location estimate for mobile device 802 or may transfer the measurements to server 840 to perform the same determination. A call from mobile device 802 may be routed, based on the location of mobile device 802, and connected to PSTN 850, for example, via wireless communication link 823 and communications link 860.

A mobile device (e.g., mobile device 802 of FIG. 8) may be referred to as a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device or some other portable or moveable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 802) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level).

The architecture of the cellular communications network described in relation to FIG. 9 may be considered to comprise a generic architecture that capable of accommodating a variety of outdoor and indoor location solutions including the standard SUPL user plane location solution defined by the Open Mobile Alliance (OMA) and standard control plane location solutions defined by 3GPP and 3GPP2. For example, server 840 may function as (i) a SUPL location platform to support the SUPL location solution, (ii) an E-SMLC to support the 3GPP control plane location solution with LTE access on wireless communication link 823 or 825, or (iii) a Standalone Serving Mobile Location Center (SAS) to support the 3GPP Control Plane Location solution for UMTS.

FIG. 9 is a second flowchart for a method of caller verification and behavior analysis, according to an embodiment. The method of FIG. 5 may begin at 905, which may include obtaining, via an application programming interface triggered or invoked at a call destination, communication parameters relevant to a call source. In particular embodiments, such triggering may occur in response to a person, such as a call center employee, for example, or may occur without human input, such as by way of a computerized interactive voice response system. 910 may include transmitting a query to a communication services carrier, wherein the query includes the obtained communication parameters. In some embodiments, communication parameters may include descriptive parameters provided by an automatic numbering identification system and/or a caller identification system. 915 may include obtaining, from a communication services carrier and in response to the query transmitted at 910, an indication of a match between a call setup record (e.g., comprising call setup parameters) generated by the communication services carrier and the communication parameters provided obtained at 905. 920 may include generating an authentication signal, with respect to the call source, responsive to detecting agreement (or a match) between the communication parameters relevant to the call source and the call setup record generated by the communication services carrier.

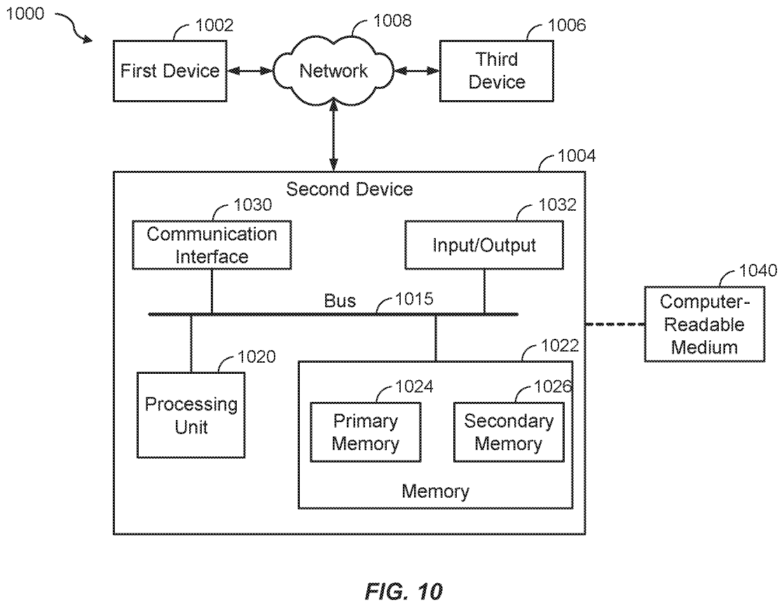

FIG. 10 is a schematic diagram illustrating an implementation of a computing device, which may correspond to call verification device 501 of FIG. 5, per-carrier call verification device 610A of FIG. 6, or call verification API server 620 of FIG. 6, according to various embodiments. In an example embodiment, as shown in FIG. 10, a system embodiment may comprise a local network (e.g., device 1004 and medium 1040) and/or another type of network, such as a computing and/or communications network. For purposes of illustration, therefore, FIG. 10 shows an embodiment 1000 of a system that may be employed to implement either type or both types of networks. Network 1008 may comprise one or more network connections, links, processes, services, applications, and/or resources to facilitate and/or support communications, such as an exchange of communication signals, for example, between a computing device, such as 1002, and another computing device, such as 1006, which may, for example, comprise one or more client computing devices and/or one or more server computing devices. By way of example, but not limitation, network 1008 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 10 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 10 and in the text associated with the foregoing figure of the present patent application.

Referring now to FIG. 10, in an embodiment, first and third devices 1002 and 1006 may be capable of rendering a graphical user interface (GUI) for a network device and/or a computing device, for example, so that a user-operator may engage in system use. Device 1004 may potentially serve a similar function in this illustration. Likewise, in FIG. 10, computing device 1002 (‘first device’ in FIG. 10) may interface with computing device 1004 (‘second device’ in FIG. 10), which may, for example, also comprise features of a client computing device and/or a server computing device, in an embodiment. Processor (e.g., processing device) 1020 and memory 1022, which may comprise primary memory 1024 and secondary memory 1026, may communicate by way of a communication bus 1025, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1004, as depicted in FIG. 10, is merely one example, and claimed subject matter is not limited in scope to this particular example.

In one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). As suggested previously, a computing device and/or a networking device may also have a subscriber identity module (SIM) card, which, for example, may comprise a detachable or embedded smart card that is able to store subscription content of a user, and/or is also able to store a contact list. It is noted, as previously mentioned, that a SIM card may also be electronic in the sense that it may simply be sorted in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to search engine providers, social network sites, business networking sites, etc. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 10, computing device 1002 may provide one or more sources of executable computer instructions in the form physical states and/or signals (e.g., stored in memory states), for example. Computing device 1002 may communicate with computing device 1004 by way of a network connection, such as via network 1008, for example. As previously mentioned, a connection, while physical, may not necessarily be tangible. Although computing device 1004 of FIG. 10 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1022 may comprise any non-transitory storage mechanism. Memory 1022 may comprise, for example, primary memory 1024 and secondary memory 1026, additional memory circuits, mechanisms, or combinations thereof may be used. Memory 1022 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1022 may be utilized to store a program of executable computer instructions. For example, processor 1020 may fetch executable instructions from memory and proceed to execute the fetched instructions. Memory 1022 may also comprise a memory controller for accessing device readable-medium 1040 that may carry and/or make accessible digital content, which may include code, and/or instructions, for example, executable by processor 1020 and/or some other device, such as a controller, as one example, capable of executing computer instructions, for example. Under direction of processor 1020, a non-transitory memory, such as memory cells storing physical states (e.g., memory states), comprising, for example, a program of executable computer instructions, may be executed by processor 1020 and able to generate signals to be communicated via a network, for example, as previously described. Generated signals may also be stored in memory, also previously suggested.

Memory 1022 may store electronic files and/or electronic documents, such as relating to one or more users, and may also comprise a computer-readable medium that may carry and/or make accessible content, including code and/or instructions, for example, executable by processor 1020 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 10, processor 1020 may comprise one or more circuits, such as digital circuits, to perform at least a portion of a computing procedure and/or process. By way of example, but not limitation, processor 1020 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 1020 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 10 also illustrates device 1004 as including a component 1032 operable with input/output devices, for example, so that signals and/or states may be appropriately communicated between devices, such as device 1004 and an input device and/or device 1004 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A caller verification system, comprising:
a signaling resource that forms a communications channel for a call placed between a call source and a call destination, the signaling resource to generate a call setup record having parameters relevant to the formed communications channel; and
a call verification device to provide call parameters to the signaling resource, and to receive from the signaling resource, an indication of a match between the provided call parameters and the parameters of the call setup record.

2. The caller verification system of claim 1, further comprising one or more number allocation databases which, responsive to a query initiated at the call destination, determines a communication services carrier from a plurality of communication services carrier that formed the communications channel between the call source and the call destination.

3. The caller verification system of claim 1, further comprising:
a processor to determine that the call placed between the call source and the call destination is fraudulent based, at least in part, on a mismatch between the provided call parameters and the parameters of the call setup record.

4. The caller verification system of claim 1, wherein the call verification device is adapted to receive a telephone number corresponding to the call source.

5. The caller verification system of claim 1, additionally adapted to transmit a query to a database to determine a trustworthiness score corresponding to a caller corresponding to the call source.

6. The caller verification system of claim 5, wherein the database comprises one or more records of events that relate to a communications device corresponding to the call source.

7. The caller verification system of claim 1, wherein the signaling resource operates in accordance with a session initiation protocol (SIP).

8. The caller verification system of claim 1, wherein the signaling resource operates in accordance with a signaling system 7 (SS7) protocol.

9. The caller verification system of claim 1, wherein the call verification device operates without user input to provide the call parameters to the signaling resource.

10. A method of authenticating a call source, comprising:
obtaining, via an application programming interface triggered at a call destination, communication parameters relevant to the call source;
transmitting a query to a communication services carrier, the query including the obtained communication parameters;
obtaining, from the communication services carrier and responsive to the transmitted query, an indication of a match between a call setup record generated by the communication services carrier and the communication parameters relevant to the call source; and
generating an authentication signal, with respect to the call source, responsive to detecting agreement between the communication parameters relevant to the call source and the call setup record generated by the communication services carrier.

11. The method of claim 10, further comprising:
receiving, from a computing device, a signal to initiate transmission of the obtained communication parameters, relevant to the call source, to the communication services carrier.

12. The method of claim 10, further comprising, prior to generating the authentication signal:
accessing a database comprising the parameters relevant to the call source.

13. The method of claim 10, wherein the call setup record generated by the communication services carrier corresponds to a signaling system 7 (SS7) record.

14. The method of claim 10, wherein the call setup record generated by the communication services carrier corresponds to Session Initiation Protocol (SIP) record.

15. The method of claim 10, wherein the agreement between the communication parameters relevant to the call source and the call setup record generated by the communication services carrier pertain to a match between a telephone number of the call source, determined from the call setup record, and a telephone number of the call source from the obtained communication parameters.

16. An article comprising:
a non-transitory storage medium having instructions stored thereon and executable by a special-purpose computing platform to:
obtain, via an application programming interface triggered at a call destination, communication parameters relevant to a call source;
transmit a query to a communication services carrier, the query including the obtained communication parameters;
obtain, responsive to the transmitted query, an indication of a match between a call setup record generated by the communication services carrier and the communication parameters relevant to establishing a resource between the call source and the call destination; and
generate an indication of authentication with respect to the call source responsive to an agreement between the communication parameters relevant to the call destination and the call setup record generated by the communication services carrier.

17. The article of claim 16, wherein the instructions executable by the special-purpose computing platform are additionally to:
access a database comprising the parameters relevant to the call destination.

18. The article of claim 16, wherein the instructions executable by the special-purpose computing platform are additionally to:
generate the call setup record in accordance with a signaling system 7 (SS7) record.

19. The article of claim 16, wherein the instructions executable by the special-purpose computing platform are additionally to:
generate the call setup record in accordance with a session initiation protocol (SIP) record.

20. The article of claim 16, wherein the agreement between the communication parameters pertains to agreement between the obtained communication parameters relevant to the call destination and the call setup record generated by the communication services carrier.
